(19) United States
(12) Patent Application Publication
(10) Pub. No.: US 2012/0290757 A1
(43) Pub. Date: Nov. 15, 2012

(54) ELECTRONIC APPARATUS AND UNIVERSAL SERIAL BUS 3.0 MODULE

(75) Inventors: CHIH-TIEN CHENG, NEW TAIPEI CITY (TW); YUANG-CHIH CHEN, NEW TAIPEI CITY (TW)

(73) Assignee: AOPEN INC., TAIPEI HSIEN (TW)

(21) Appl. No.: 13/414,642

(22) Filed: Mar. 7, 2012

(30) Foreign Application Priority Data
May 13, 2011 (TW) TW100116812

(51) Int. Cl. G06F 13/00; G06F 13/36

(52) U.S. Cl. 710/301; 710/315

(57) ABSTRACT

The invention provides an electronic apparatus. In one embodiment, the electronic apparatus comprises a motherboard, a Universal Serial Bus (USB) 3.0 module, and a Peripheral Component Interconnect Express (PCIe) interface. The motherboard comprises a host chip and a power supply module. The USB 3.0 module comprises a USB 3.0 controller chip and a USB 3.0 connector, wherein a USB 3.0 connector is located on a front panel of the electronic apparatus. The PCIe interface couples the USB 3.0 module with the motherboard, transmits a set of PCIe signals between the host chip and the USB 3.0 controller chip, and sends a power generated by the power supply module to the USB 3.0 controller chip and the USB 3.0 connector.

### CROSS REFERENCE TO RELATED APPLICATIONS

This Application claims priority of Taiwan Patent Application No. 100116812, filed on May 13, 2011, the entirety of which is incorporated by reference herein.

### BACKGROUND OF THE INVENTION

1. Field of the Invention

The invention relates to a Universal Serial Bus (USB), and more particularly to USB 3.0 circuits.

2. Description of the Related Art

Universal Serial Bus (USB) is a standard of a serial data transmission port interface for connection between a computer system and a peripheral device. Before a peripheral device using a conventional interface is connected to a computer system, a driver of the peripheral device must be installed to the computer system, such as a Comport interface for printers, an RS232 interface for modems, and a PS/2 interface for mouse and keyboards. The driver installation therefore induces inconvenience for a user of the computer system. Because the USB standard supports a Hot-plug function and a Plug-and-Play function, the USB interface is more convenient than other conventional interfaces for a user of a computer system. The USB interface is therefore widely used in digital communication products for personal computers and portable devices.

Currently available USB interfaces are divided into USB 2.0 interfaces and USB 3.0 interfaces. A USB 2.0 interface has a data transfer rate of 480 Mbps, and a USB 3.0 interface has a data transfer rate of 5 Gbps. The data transfer rate of the USB 3.0 interface is therefore much higher than that of the USB 2.0 interface. To maintain the high data transfer rate, the signal quality required by the USB 3.0 interface is also much higher than that of the USB 2.0 interface.

Referring to FIG. 1, a schematic diagram of USB connectors of a conventional computer system is shown. A conventional computer system 100 has a back panel comprising two USB connectors 104 and 106. The USB connectors 104 and 106 are located on the back panel of the computer system 100 to be coupled with a motherboard 102 of the computer system 102. Because the USB connectors 104 and 106 are located on the back panel, a user must reverse the computer system 100 to plug USB devices to the USB connectors 104 and 106, inducing inconvenience for the user. A new-type computer system therefore comprises USB connectors located on a front panel of the computer system for convenience of a user. Referring to FIG. 2, a schematic diagram of USB connectors of a new-type computer system 200 is shown. The computer system 200 has a motherboard 202. Two USB connectors 204 and 206 are located on a front panel of the computer system 200. Because a USB slot 208 of the motherboard 202 is often located on a rear area of the computer system 200, the distance between the USB connectors 204 and 206 and the USB slot 208 is long, and a flat cable is therefore required to connect the USB connectors 204 and 206 to the USB slot 208 of the motherboard 202. The flat cable degrades the quality of signals transmitted between the USB slot 208 and the USB connectors 204 and 206, and leads to data errors of the computer system 200.

Referring to FIG. 3, a schematic diagram of a coupling relationship between a USB connector 304 and a motherboard 302 of a new-type computer system is shown. The motherboard 302 comprises a pin header 310. A printed circuit board (PCB) of a USB 3.0 connector 304 also has a pin header 308. The pin header 308 is coupled to the pin header 310 via a flat cable 306. A signal received by the USB connector 304 therefore must sequentially pass the pin header 308, the flat cable 306, and the pin header 310 to be received by the motherboard 302. Both the pin headers 310 and 308 attenuate the transmitted signal, and degrade the quality of the transmitted signal. Similarly, a power supplied by the motherboard 302 therefore must sequentially pass the pin header 310, the flat cable 306, and the pin header 308 to arrive at the USB connector 304. Both the pin headers 310 and 308 attenuate the supplied power, and induce a problem of power loss. The flat cable 306 also degrades the quality of the transmitted signal and deteriorates the power loss problem. The performance of the new-type computer system is therefore degraded. To solve the aforementioned problem of power loss and signal quality degradation, a new USB 3.0 module is provided.

### BRIEF SUMMARY OF THE INVENTION

The invention provides an electronic apparatus. In one embodiment, the electronic apparatus comprises a motherboard, a Universal Serial Bus (USB) 3.0 module, and a Peripheral Component Interconnect Express (PCIe) interface. The motherboard comprises a host chip and a power supply module. The USB 3.0 module comprises a USB 3.0 controller chip and a USB 3.0 connector, wherein a USB 3.0 connector is located on a front panel of the electronic apparatus. The PCIe interface couples the USB 3.0 module with the motherboard, transmits a set of PCIe signals between the host chip and the USB 3.0 controller chip, and sends a power generated by the power supply module to the USB 3.0 controller chip and the USB 3.0 connector.

The invention provides a Universal Serial Bus (USB) 3.0 module. In one embodiment, the USB 3.0 module comprises a USB 3.0 connector, a USB 3.0 controller chip, and a Peripheral Component Interconnect Express (PCIe) interface. The USB 3.0 connector is located on a front panel of an electronic apparatus. The USB 3.0 controller chip sends a set of USB 3.0 signals to the USB 3.0 connector. The PCIe interface couples the USB 3.0 module with a motherboard, transmits a set of PCIe signals between the motherboard and the USB 3.0 controller chip, and sends a power generated by the motherboard to the USB 3.0 controller chip and the USB 3.0 connector.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of USB connectors of a conventional computer system;

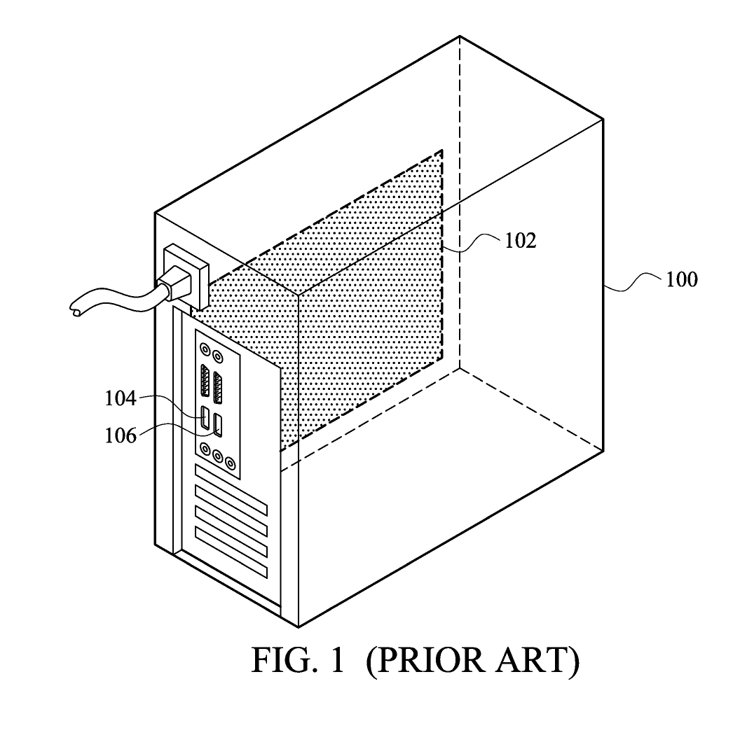

FIG. 2 is a schematic diagram of USB connectors of a new-type computer system;

FIG. 3 is a schematic diagram of a coupling relationship between a USB connector and a motherboard of a new-type computer system;

FIG. 4 is a block diagram of an electronic apparatus according to the invention;

FIG. 5 is a third-dimensional schematic diagram of a coupling relationship between a motherboard and a USB 3.0 module according to the invention;

FIG. 6 is a schematic diagram of a lateral view of a connection relationship between a USB 3.0 module and a motherboard according to the invention;

FIG. 7 is a flowchart of a method for preventing an over-current problem of a USB 3.0 module of an electronic apparatus according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

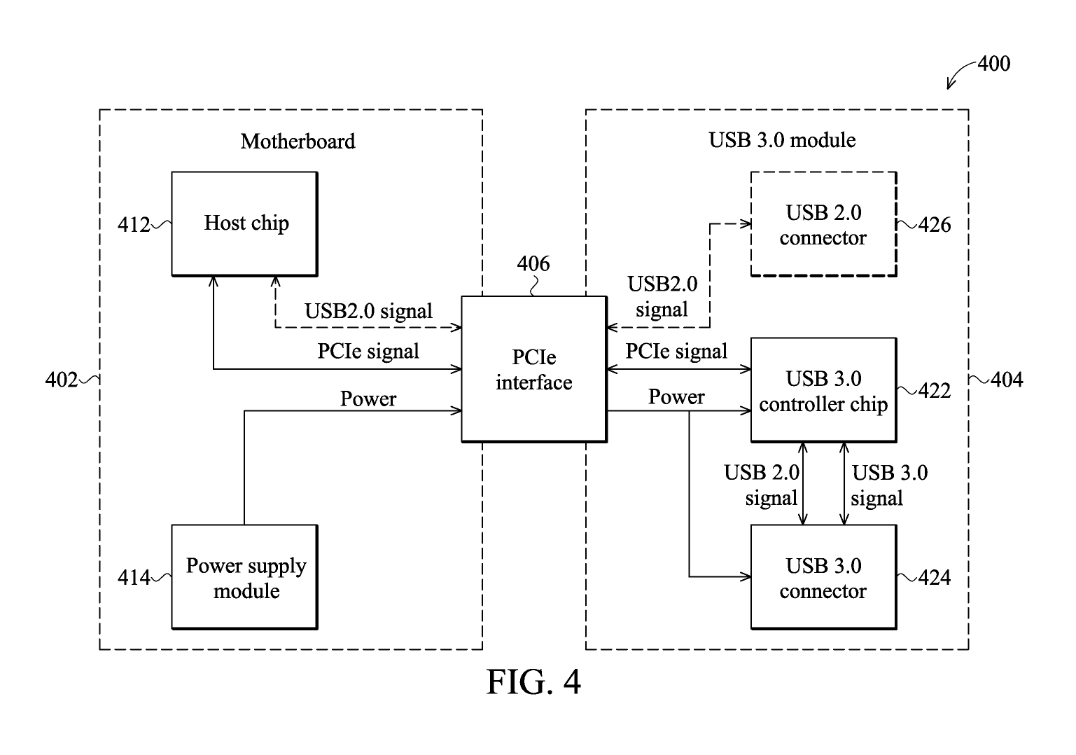

Referring to FIG. 4, a block diagram of an electronic apparatus 400 according to the invention is shown. In one embodiment, the electronic apparatus 400 is a computer, a media playing device, or a portable device. The electronic apparatus 400 comprises a motherboard 402, a Universal Serial Bus (USB) 3.0 module 404, and a Peripheral Component Interconnect Express (PCIe) interface 406. In one embodiment, the USB 3.0 module 404 comprises a USB 3.0 controller chip 422 and a USB 3.0 connector 424. The USB 3.0 connector 424 is located at a front panel of the electronic apparatus 400 for convenience of a user. The USB 3.0 controller chip 422 generates a set of USB 3.0 signals to control the operation of the USB 3.0 connector 424.

The PCIe interface 406 directly couples the USB 3.0 module 404 with the motherboard 402 without any pin headers and flat cables. The motherboard 402 comprises a host chip 412 and a power supply module 414. The PCIe interface 406 transmits a set of PCIe signals between the host chip 412 of the motherboard 402 and the USB 3.0 controller chip 422 of the USB 3.0 module 404. The host chip 412 sends the PCIe signals to the USB 3.0 module 404 to control the USB 3.0 controller chip 422 of the USB 3.0 module 404, and the USB 3.0 controller chip 422 reports information about a status of the USB 3.0 connector 424 to the host chip 412 via the PCIe signals. The power module 414 generates a power, and the PCIe interface 406 also transmits the power to the USB 3.0 module 404 to supply the USB 3.0 controller chip 422 and the USB 3.0 connector 424 with the power.

When the host chip 412 wants to send data to a peripheral device connected to the USB 3.0 connector 424, the host chip 412 converts the data to a PCIe signal, the PCIe interface 406 then transmits the PCIe signal comprising the data to the USB 3.0 controller chip 422, and the USB 3.0 controller chip 422 then converts the PCIe signal to a USB 3.0 signal and a USB 2.0 signal and sends the USB 3.0 signal and the USB 2.0 signal to the peripheral device via the USB 3.0 connector 424. When the USB 3.0 connector 424 receives data sent from the peripheral device, the USB 3.0 connector 424 forwards a USB 3.0 signal and a USB 2.0 signal comprising the data to the USB 3.0 controller chip 422, the USB 3.0 controller chip 422 then converts the USB 3.0 signal and the USB 2.0 signal to a PCIe signal and sends the PCIe signal to the PCIe interface 406, and the PCIe interface 406 then sends the PCIe signal to the host chip 412 of the motherboard 402.

In another embodiment, the USB 3.0 module 404 does not comprise a USB 3.0 controller chip 422 and a USB 3.0 connector 424, and comprises a USB 2.0 connector 426 instead. The USB 2.0 connector 426 is located at a front panel of the electronic apparatus 400. The PCIe interface 406 transmits a set of USB 2.0 signals between the USB 2.0 connector 426 of the USB 3.0 module 404 and the host chip 412 of the motherboard 402. The host chip 402 generates the USB 2.0 signals, and the PCIe interface 406 then forwards the USB 2.0 signals to the USB 2.0 connector chip 426 to control the operation of the USB 2.0 connector 426. The USB 3.0 module 404 therefore becomes a USB 2.0 module.

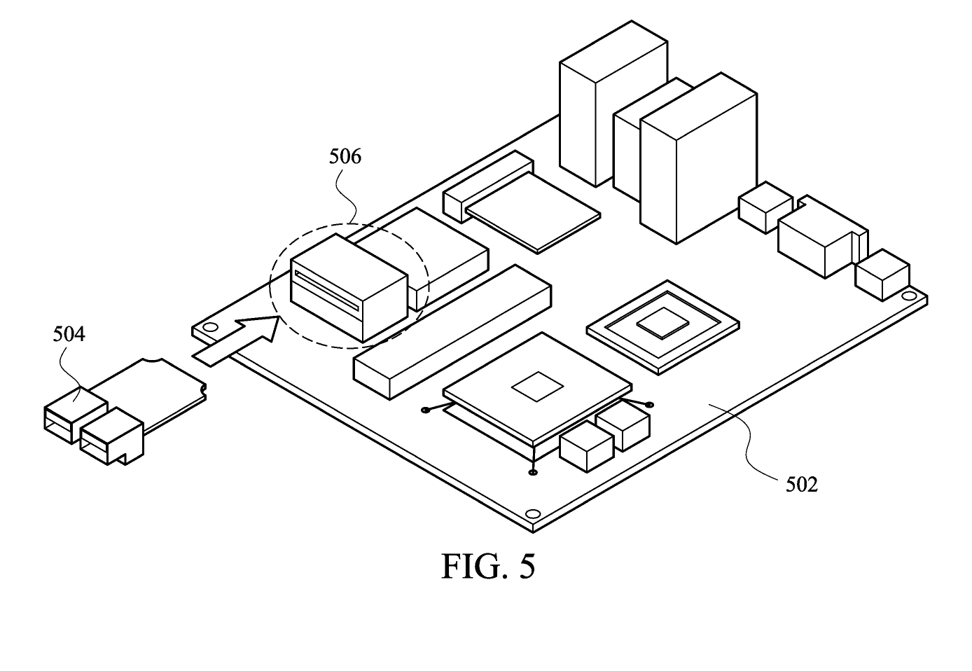

Referring to FIG. 5, a third-dimensional schematic diagram of a coupling relationship between a motherboard 502 and a USB 3.0 module 504 according to the invention is shown. The PCB 504 of the USB 3.0 module comprises a USB 3.0 connector and a USB 3.0 controller chip, and the slot of the USB 3.0 connector is located at a front panel of an electronic apparatus comprising the motherboard 502. The PCB 504 of the USB 3.0 module is installed in the electronic apparatus in parallel with the motherboard 502 of the electronic apparatus. The USB 3.0 module 504 is directly coupled to the motherboard 502 via the PCIe interface 506, and the PCIe interface 506 is perpendicular to both the PCB of the USB 3.0 module 504 and the motherboard 502. In one embodiment, the PCIe interface 505 is coupled to the PCB 504 of the USB 3.0 module via a PCIe mini card connector, and the PCIe interface 506 is coupled to the motherboard 502 via a PCIex1 slot connector.

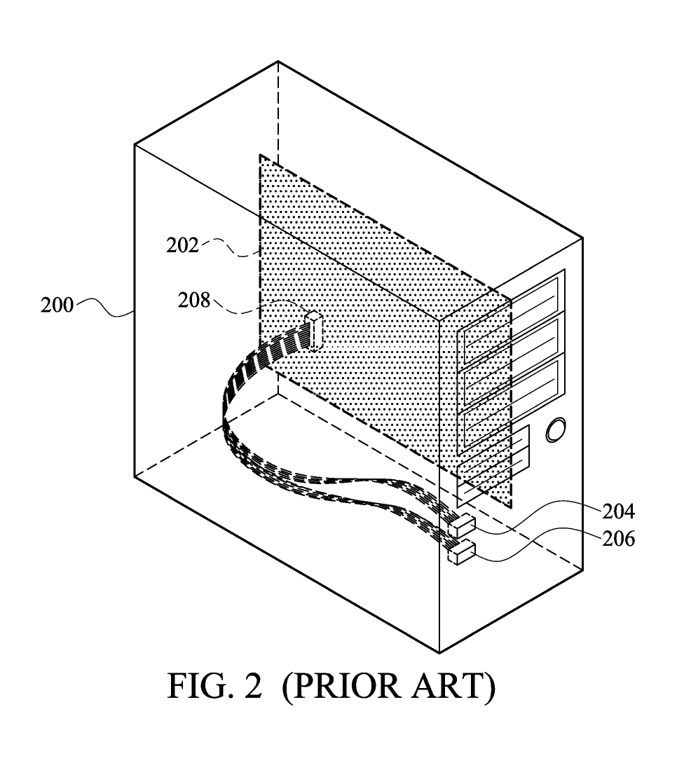

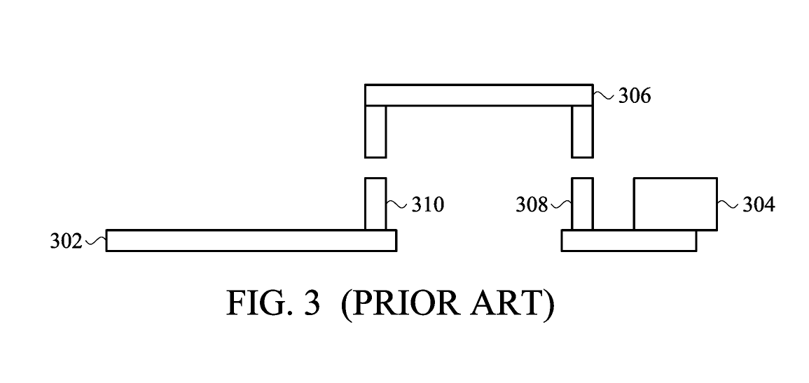

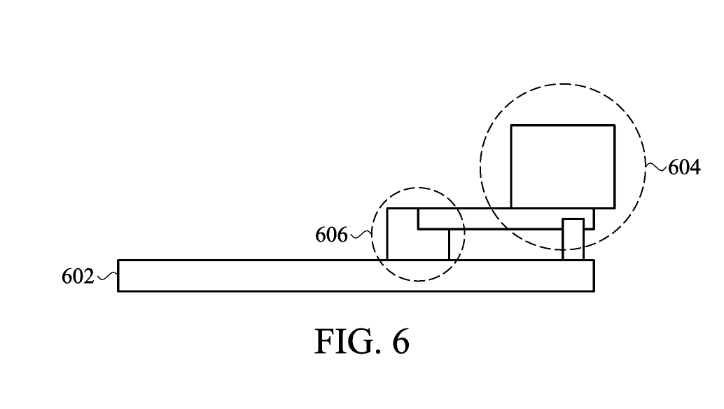

Referring to FIG. 6, a schematic diagram of a lateral view of a connection relationship between a USB 3.0 module 604 and a motherboard 602 according to the invention is shown. The PCB of the USB 3.0 module 604 is in parallel with the motherboard 602. The PCB of the USB 3.0 module 604 is coupled to the motherboard 602 via the PCIe interface 606, wherein the PCIe interface 606 is perpendicular to both the PCB of the USB 3.0 module 604 and the motherboard 602. Because the USB 3.0 module 604 is directly coupled to the motherboard 602 via the PCIe interface 606 without a flat cable or pin headers as shown in FIGS. 2 and 3, the signals transmitted between the USB 3.0 module 604 and the motherboard 602 do not have signal attenuation induced by the flat cable and the pin headers, and the signal quality is therefore maintained to be good, and no data errors is induced. In addition, the power of the USB 3.0 connector 604 is supplied by the motherboard 602 via the PCIe interface without a flat cable and pin headers. Because the USB 3.0 module 604 is directly coupled to the motherboard 602 via the PCIe interface 606 without a flat cable or pin headers as shown in FIGS. 2 and 3, the power supplied to the USB 3.0 module 604 from the motherboard 602 is not attenuated by the flat cable and the pin headers, and the power level supplied to the USB 3.0 module 604 is therefore ensured to be high enough, and no power deficiency is induced. The USB 3.0 module 604 according to the invention therefore solves the problem of signal attenuation and power deficiency of the conventional art shown in FIGS. 2 and 3, and the performance of data transmission of the USB 3.0 module 604 is therefore improved.

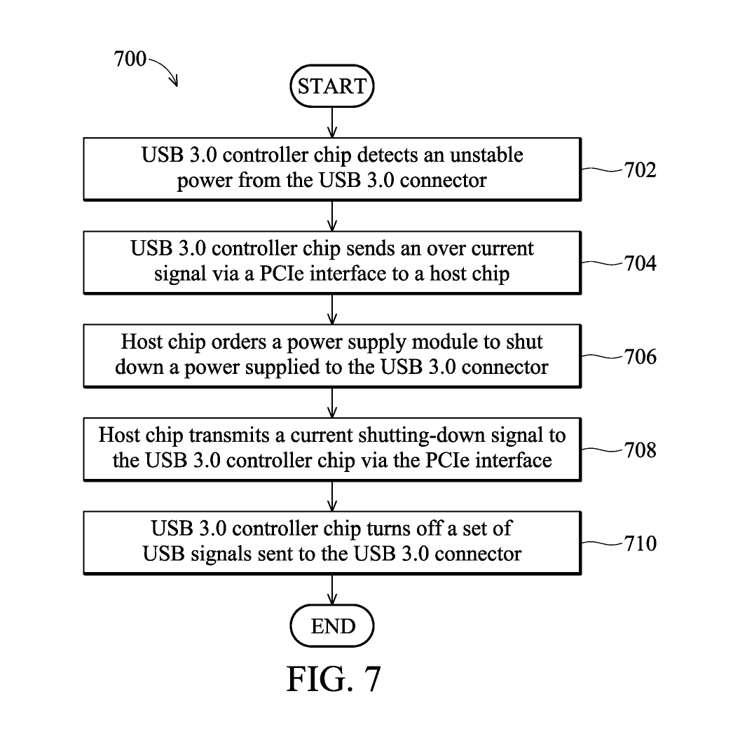

Referring to FIG. 7, a flowchart of a method for preventing an over-current problem of the USB 3.0 module 404 of the electronic apparatus 400 according to the invention is shown. When the USB 3.0 controller chip 422 detects unstable power from the USB 3.0 connector 424, the unstable power of the USB 3.0 connector 424 may lead to errors of data transmission, and the host chip 412 of the motherboard 402 must mitigate the unstable power of the USB 3.0 connector 424. First, the USB 3.0 controller chip 422 detects an unstable power from the USB 3.0 connector 424 (step 702). The USB 3.0 controller chip 422 then sends an over current signal via a PCIe interface 406 to the host chip 412 (step 704). The host chip 412 then orders a power supply module 414 to shut down a power supplied to the USB 3.0 connector 424 (step 706). The host chip 412 then transmits a current shutting-down signal to the USB 3.0 controller chip 422 via the PCIe interface 406 (step 708). Finally, the USB 3.0 controller chip 422 turns off a set of USB signals sent to the USB 3.0 connector 424 (step 710).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus, comprising:
a motherboard, comprising a host chip and a power supply module;
a Universal Serial Bus (USB) 3.0 module, comprising a USB 3.0 controller chip and a USB 3.0 connector, wherein a USB 3.0 connector is located on a front panel of the electronic apparatus; and
a Peripheral Component Interconnect Express (PCIe) interface, coupling the USB 3.0 module with the motherboard, transmitting a set of PCIe signals between the host chip and the USB 3.0 controller chip, and sending a power generated by the power supply module to the USB 3.0 controller chip and the USB 3.0 connector.

2. The electronic apparatus as claimed in claim 1, wherein the USB 3.0 controller chip sends a set of USB 3.0 signals to the USB 3.0 connector according to the PCIe signals received from the PCIe interface.

3. The electronic apparatus as claimed in claim 1, wherein the PCIe interface is coupled to the motherboard via a mini card connector, and the PCIe interface is coupled to the USB 3.0 module via a PCIex1 slot connector.

4. The electronic apparatus as claimed in claim 1, wherein a printed circuit board (PCB) of the USB 3.0 module is installed in the electronic apparatus in parallel to the motherboard and coupled to the motherboard via a connector of the PCIe interface, wherein the connector of the PCIe interface is perpendicular to the motherboard and the PCB of the USB 3.0 module.

5. The electronic apparatus as claimed in claim 1, wherein when the USB 3.0 controller chip detects an unstable voltage from the USB 3.0 connector, the USB 3.0 controller chip sends an over current signal via the PCIe interface to the host chip, and switches off a set of USB 3.0 signals sent from the USB 3.0 controller chip to the USB 3.0 connector after the USB 3.0 controller chip receives a current shutting-down signal sent by the host chip via the PCIe interface.

6. The electronic apparatus as claimed in claim 5, wherein when the host chip receives the over current signal sent by the USB 3.0 controller chip via the PCIe interface, the host chip orders the power supply module to shut down the power sent to the USB 3.0 connector, and sends the current shutting-down signal to the USB 3.0 controller chip via the PCIe interface.

7. A Universal Serial Bus (USB) 3.0 module, comprising:
a USB 3.0 connector, located on a front panel of an electronic apparatus;
a USB 3.0 controller chip, sending a set of USB 3.0 signals to the USB 3.0 connector;
a Peripheral Component Interconnect Express (PCIe) interface, coupling the USB 3.0 module with a motherboard, transmitting a set of PCIe signals between the motherboard and the USB 3.0 controller chip, and sending a power generated by the motherboard to the USB 3.0 controller chip and the USB 3.0 connector.

8. The USB 3.0 module as claimed in claim 7, wherein the motherboard comprises:
a host chip, generating the set of PCIe signals; and
a power supply module, generating the power supplied to the USB 3.0 controller chip.

9. The USB 3.0 module as claimed in claim 7, wherein the PCIe interface is coupled to the motherboard via a mini card connector, and the PCIe interface is coupled to the USB 3.0 module via a PCIex1 slot connector.

10. The USB 3.0 module as claimed in claim 7, wherein the USB 3.0 connector and the USB 3.0 controller chip are located on a printed circuit board (PCB) of the USB 3.0 module, the PCB of the USB 3.0 module is installed in the electronic apparatus in parallel to the motherboard and coupled to the motherboard via a connector of the PCIe interface, wherein the connector of the PCIe interface is perpendicular to the motherboard and the PCB of the USB 3.0 module.

11. The USB 3.0 module as claimed in claim 8, wherein when the USB 3.0 controller chip detects an unstable voltage from the USB 3.0 connector, the USB 3.0 controller chip sends an over current signal via the PCIe interface to the host chip, and switches off a set of USB 3.0 signals sent from the USB 3.0 controller chip to the USB 3.0 connector after the USB 3.0 controller chip receives a current shutting-down signal sent by the host chip via the PCIe interface.

12. The USB 3.0 module as claimed in claim 11, wherein when the host chip receives the over current signal sent by the USB 3.0 controller chip via the PCIe interface, the host chip orders the power supply module to shut down the power sent to the USB 3.0 connector, and sends the current shutting-down signal to the USB 3.0 controller chip via the PCIe interface.
